(19) United States
(12) Patent Application Publication
(10) Pub. No.: US 2013/0251176 A1
(43) Pub. Date: Sep. 26, 2013

(54) EXCITER AND ITS INSTALLATION METHOD, AND ACOUSTIC TRANSMISSION MEMBER

(71) Applicant: GOTO DENSHI CO.,LTD., Sagae-shi (JP)

(72) Inventors: Yoshihide GOTO, Sagae-shi (JP); Taiki GOTO, Sagae-shi (JP)

(73) Assignee: GOTO DENSHI CO.,LTD., Sagae-shi (JP)

(21) Appl. No.: 13/840,597

(22) Filed: Mar. 15, 2013

(30) Foreign Application Priority Data
Mar. 22, 2012 (JP) 2012-065806

(51) Int. Cl. H04R 1/00

(52) U.S. Cl. CPC H04R 1/00
USPC 381/152

(57) ABSTRACT

An exciter assembly includes a magnetostriction element and a holder encasing the magnetostriction element. The holder is provided with a groove which is positioned on at least a part of an outer circumstance of the holder. The exciter according to embodiments of the present invention is capable of generating a large sound and may be installed easily. A method of its installation and an acoustic transmission member including said exciter are also provided.

This application claims priority under 35 U.S.C. §119 to Japanese Patent Application Serial No. 2012-65806, filed on Mar. 22, 2012, entitled “Exciter and its installation method, and acoustic transmission member”, which is hereby expressly incorporated by reference in its entirety for all purposes.

### TECHNICAL FIELD

The present invention relates to an exciter, a method for its installation, and acoustic transmission member.

### BACKGROUND OF THE DISCLOSURE

A variety of exciters employing a magnetostriction element have been developed in the past. These exciters are typically used by being attached to members such as tables, doors, partitions, walls and etc. The above-mentioned magnetostriction element vibrates in response to an input audio signal, and this vibration is transmitted to the above-mentioned member. With this, a sound corresponding to the above-mentioned audio signal can be generated with a high volume through the above-mentioned member.

However, many problems arise when installing an exciter to the above-mentioned member. For example, the number of processes required to install a conventional exciter may be excessively large. Or, installing a conventional exciter may require high-level skill sets. Furthermore, after installation, conventional exciters have a poor transmission efficiency of the vibration to the member, and therefore, the audio volume of the generated sound may be overly small. The above-mentioned problems become especially prominent when installing the exciters to members having a flash structure.

### SUMMARY OF THE INVENTION

An object of the present invention is to provide an exciter that is easy to install and capable of generating a large sound; a method of installing it; and an acoustic transmission member provided with the above-mentioned exciter.

In accordance with one aspect of the present invention, an exciter includes a magnetostriction element and a holder encasing the magnetostriction element. The holder is provided with a groove which is positioned on at least a part of an outer circumstance of the holder.

In accordance with a second aspect of the present invention, an acoustic transmission member is provided. The acoustic transmission member includes a first board, a second board facing the first board, and a core intervening between the first board and the second board. An exciter including a magnetostriction element encased by a holder is mounted on a bottom surface of the second board so as to pass through the second board and to have contact with the first board either directly or indirectly by way of a spacer.

In accordance with a third aspect of the present invention, a method for mounting an exciter includes the steps of preparing a member provided with an aperture and screwing the exciter which has a magnetostriction element encased by a holder into said aperture.

According to Embodiments of the present invention, it is possible to provide an exciter that is easy to install and capable of generating a large sound; a method of installing it; and an acoustic transmission member including the above-mentioned exciter.

### BRIEF DESCRIPTION OF DRAWINGS

FIG. 1 is a cross-sectional view of an exciter according to one embodiment of the present invention.

FIG. 2 is an exploded view showing the exciter of FIG. 1 before assembly.

FIG. 3 is a cross-sectional view of the exciter according to a modification example of the present invention.

FIG. 4 is a cross-sectional view showing the exciter according to another modification example of the present invention during assembly.

FIG. 5 is an enlarged cross-sectional view showing a part of the exciter shown in FIG. 4.

FIG. 6 is a top view and a cross-sectional view of the exciter according to another modification example of the present invention.

FIG. 7 is a cross-sectional view showing an example of an acoustic transmission member provided with an exciter.

FIG. 8 is a cross-sectional view showing an example of a method of installing an exciter.

FIG. 9 is a cross-sectional view showing another example of an acoustic transmission member provided with an exciter.

FIG. 10 is a cross-sectional view showing a modification example of the acoustic transmission member shown in FIG. 9.

### DETAILED DESCRIPTION OF THE INVENTION

Embodiments of the present invention will be described hereinafter with reference to the accompanying drawings, in which preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing preferred exemplary embodiments of the disclosure. It should be noted that this invention may be embodied in different forms without departing from the spirit and scope of the invention as set forth in the appended claims.

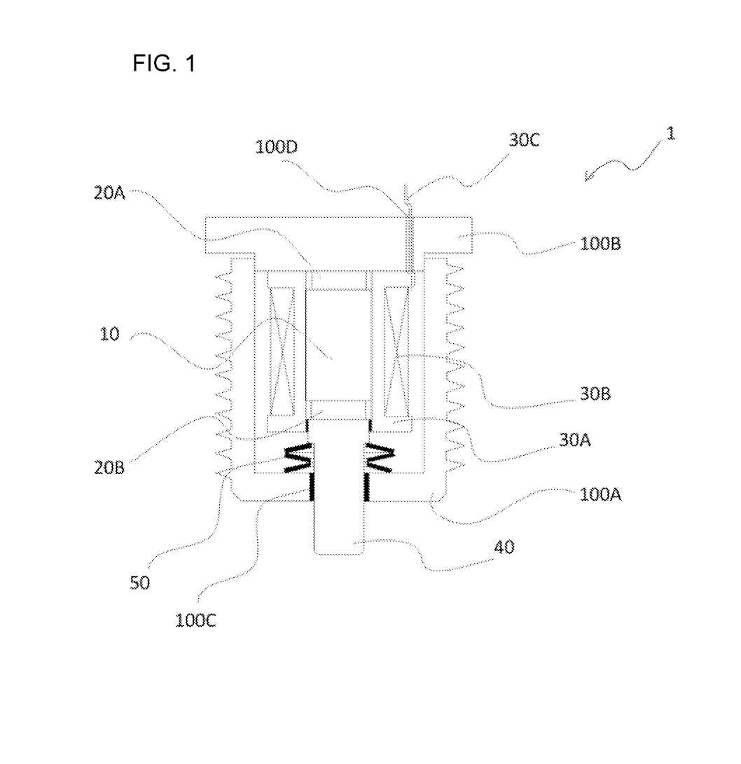

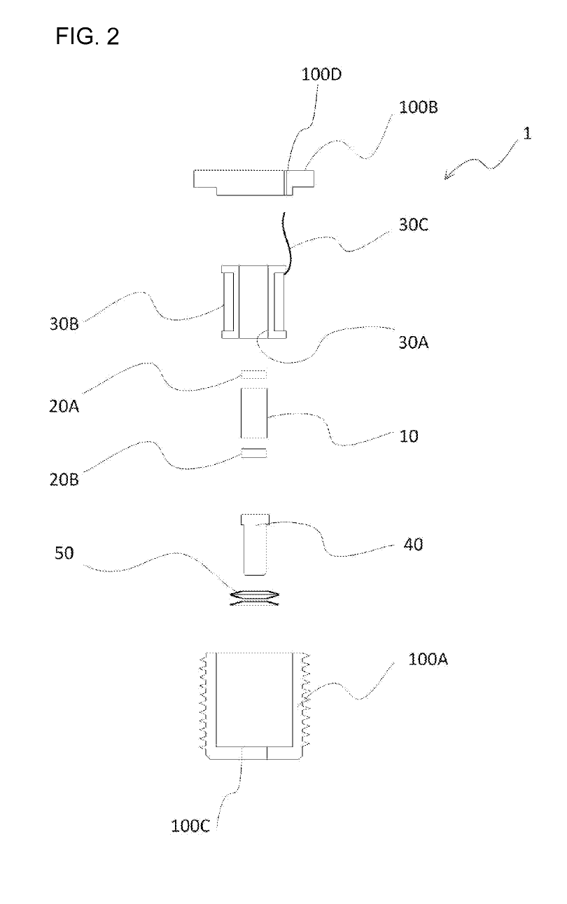

FIG. 1 is a cross-sectional view of an exciter according to one embodiment of the present invention. FIG. 2 is an exploded view of the exciter shown in FIG. 1 before assembly.

The exciter 1 shown in FIG. 1 and FIG. 2 is provided with a magnetostriction element 10, magnets 20A and 20B, coil bobbin 30A, coil 30B, input lead wire 30C, vibrating rod 40, disc spring 50, holder 100A, and holder head 100B. A through-hole 100C for passing the vibrating rod 40 is provided in the holder 100A. A through-hole 100D for passing the input lead wire 30C is provided in the holder head 100B. These respective parts are explained below.

The magnetostriction element 10 is an element that changes elasticity in response to an applied magnetic field. A cylindrical magnetostriction element can be used as magnetostriction element 10, for example. As magnetostriction element 10, a cylindrical magnetostriction element having a diameter of 3.5 mm and height of 6 mm can be used, for example.

Magnets 20A and 20B have been magnetized. Magnets 20A and 20B are used for applying a bias magnetic field. Magnets 20A and 20B are disposed facing each other so as to sandwich the magnetostriction element 10. As magnets 20A and 20B, a neodymium magnet can be used, for example. As magnets 20A and 20B, a cylindrical magnet having a diameter of 3 mm and a height of 1 mm can be used, for example.

A coil wire is wound on the coil bobbin 30A, and this coil wire forms the coil 30B. The coil bobbin 30A is manufactured by resin molding, for example. This coil bobbin 30A, for example, has a height of 9 mm, an outer diameter of 8 mm, an inner diameter of 4 mm, and the thickness of about 1 mm. Further, the winding width of the coil 30B is about 8 mm and the direct current resistance is 5Ω, for example. The input lead wire 30C is electrically connected to an end of the coil wire constituting coil 30B. This connection can be made by soldering, for example.

The vibrating rod 40 is configured to transmit vibrations from the magnetostriction element 10 to outside of the holder 100A. The vibrating rod 40 is made of iron, for example. The vibrating rod 40 has a shape wherein cylinders of different diameters are mutually overlapped, for example. In this case, the cylinder with a larger diameter has a diameter of 3.4 mm and a height of 1.5 mm, for example. The cylinder with a smaller diameter has a diameter of 2.95 mm and a height of 6 mm, for example. Typically, an end of the larger diameter side of the vibrating rod 40 faces the magnetostriction element 10 through the magnet 20B.

Three disc springs 50 are stacked alternately and inserted, for example. Each of these disc springs 50 has an inner diameter of 3.2 mm and an outer diameter of 5.4 mm, for example.

The holder 100A and holder head 100B include the magnetostriction element 10 in inside. The holder 100A and holder head 100B are made of iron, for example. At least in one part of the outer circumference of the holder 100A is provided with a groove. This groove may be provided in the entire outer circumference of the holder 100A or only in a part thereof. There is no particular limitation to the shape of the groove. As mentioned above, a through-hole 100C for passing the vibrating rod 40 is provided in the holder 100A. Also, as mentioned above, a through-hole 100D for passing the input lead wire 30C through is provided in the holder head 100B.

The holder 100A, for example, has a height of 13 mm, an outer diameter of 14 mm, an inner diameter of 9.5 mm, and the thickness of the bottom part of 1.5 mm. A groove provided on the outer periphery of the holder 100A conforms to JIS Standard M14×P2 (coarse thread), for example.

The holder head 100B, for example, has a shape of cylinders having different diameters overlapped with each other. In this case, the cylinder with a larger diameter, for example, has a diameter of 15 mm and a height of 2 mm. The cylinder with a smaller diameter has a diameter of 9.5 mm and a height of 1 mm, for example. In addition, knurling can also be formed in the outer circumference of the holder head 100B.

The diameter of the through-hole 100C, for example, is 3.05 mm. The diameter of the through-hole 100D, for example, is 2.7 mm.

The above components are assembled as shown in FIG. 1. Here, the holder 100A and the holder head 100B can be adhered using an adhesive if needed. When passing the input lead wire 30C through the through-hole 100D, a protective tube can be provided around the input lead wire 30C if needed.

Various modifications are possible for the exciter described above.

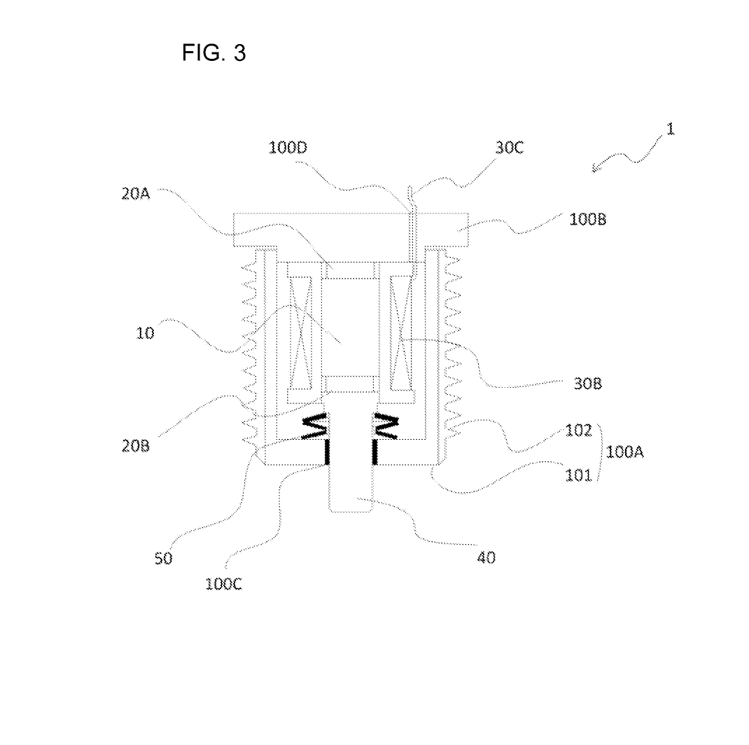

FIG. 3 shows a cross-sectional view of an exciter according to a modification example of the present invention. The exciter 1 shown in FIG. 3 has the same configuration as the exciter described with reference to FIG. 1 and FIG. 2 except for the fact that the configuration of the holder 100 is different.

In the exciter 1 shown in FIG. 3, the holder 100A includes a holder body 101 and a groove 102 formed on the periphery of the holder body as separate members. The holder body 101 and the groove portion 102 may be formed of the same material or different materials. In the latter case, the holder body 101 may be formed from iron, and the groove portion 102 may be formed from a resin, for example.

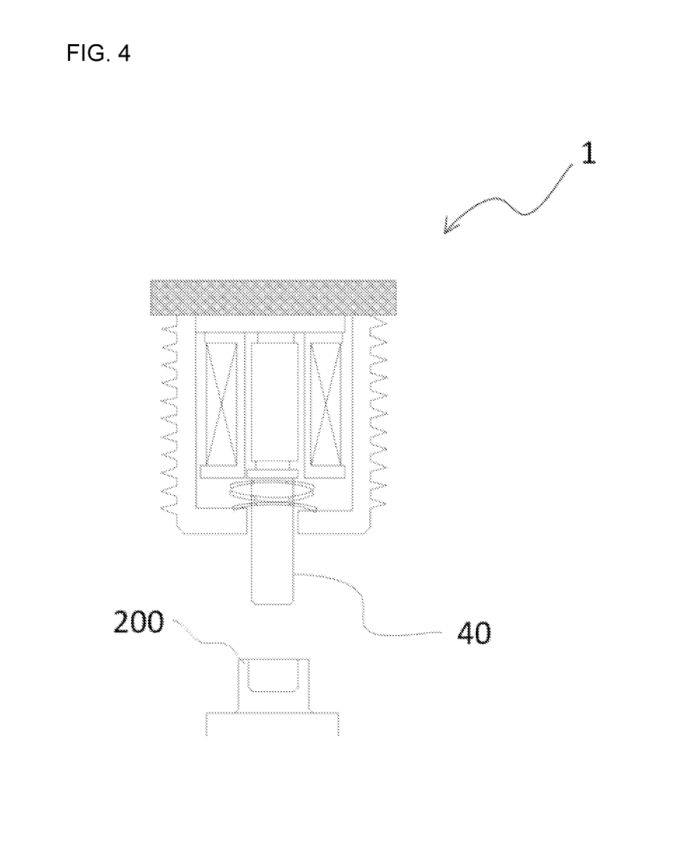

FIG. 4 is a cross-sectional view showing the exciter according to another modification example of the present invention during assembly. The exciter 1 shown in FIG. 4 has the similar configuration to the exciter explained with reference to FIG. 1 and FIG. 2 except for that the exciter 1 shown in FIG. 4 further includes a vibrating pad 200.

The vibrating pad 200 is installed so as to contact the tip of the vibrating rod 40. Further, the vibrating pad 200 has a larger diameter compared to the vibrating rod 40. By using the vibrating pad 200, vibration of the magnetostriction element 10 can be transmitted more efficiently.

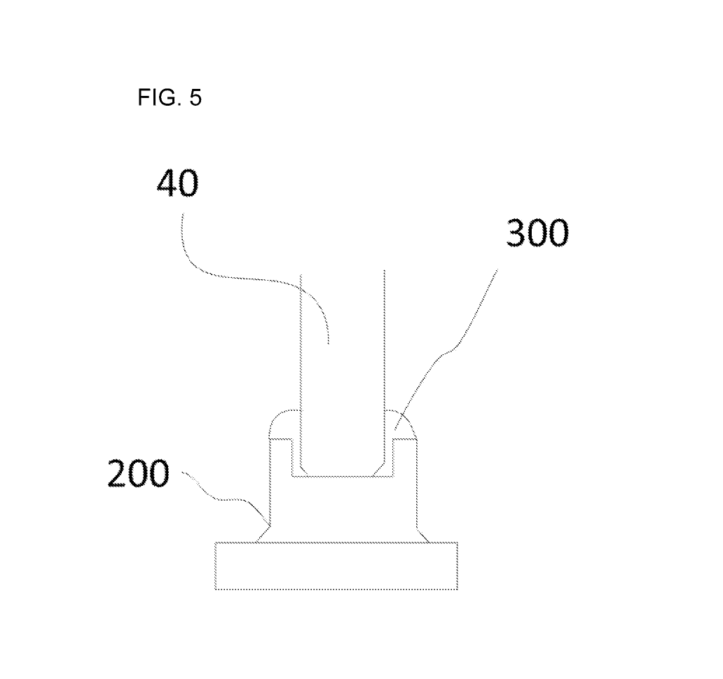

FIG. 5 is a magnified cross-sectional view showing a part of the exciter shown in FIG. 4. FIG. 5 shows an example of how the vibrating rod 40 and the vibrating pad 200 are contacted. In the example shown in FIG. 5, the vibrating rod 40 is fitted into a recessed part provided in the vibrating pad 200. Further, in this example, the vibrating rod 40 and the vibration pad 200 are connected to each other via an adhesive 300. It is possible to use an adhesive gel as the adhesive 300, for example. It is also possible to omit the adhesive 300. It is also possible to fit the vibrating pad 200 to the side of an acoustic transmission plate.

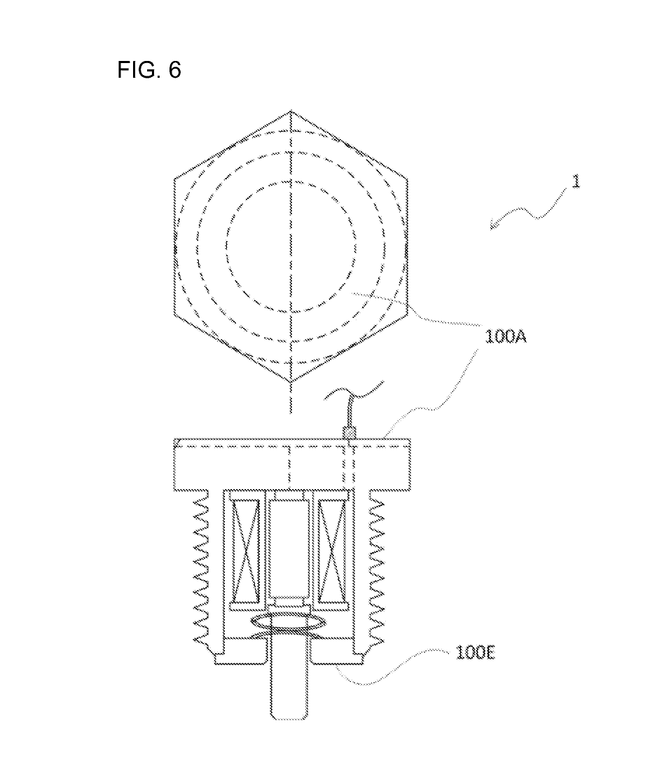

FIG. 6 is a top view and a cross-sectional view of the exciter according to another modification example of the present invention. The exciter 1 shown in FIG. 6 has the similar configuration as the exciter described with reference to FIG. 1 and FIG. 2 except for the fact that the holder has a different configuration.

The exciter 1 shown in FIG. 6 includes a holder 100A and a holder cap 100E. The holder 100A is provided with a hexagonal bolt-shaped head, and a main body portion provided with a groove in at least a part of the outer periphery. The main body portion and the head portion are integrally molded. The length of an opposite side of the head portion is 17 mm, for example. The head portion can have any shape, and it is not necessary to be in the form of a hexagonal bolt. For example, the head portion may also be in the form of an eyebolt or wing bolt.

The holder cap 100E is combined with holder 100A, and a magnetostriction element 10 is contained in the inside. The holder cap 100E, for example, has a shape of cylinders having different diameters overlapped with each other. In this case, the cylinder with a larger diameter has a diameter of 11.5 mm, for example. The cylinder with a smaller diameter has a diameter of 9.5 mm, for example. A through-hole 100C for passing the vibrating rod 40 is provided in the holder cap 100E. The diameter of the through-hole 100C is 3.2 mm, for example.

As described above, the exciter 1 shown in FIG. 6 is provided with a holder 100A wherein the head portion and body portion are integrated. By employing such a configuration, it is possible to further increase the strength of the exciter 1. Also, in this manner, firmer tightening of the exciter 1 becomes possible. Therefore, by using an exciter 1 shown in FIG. 6, it becomes possible to generate a larger and more stable sound, for example.

A member provided with an aperture is prepared, and the exciter described above can be attached to the member by screwing it into the aperture. The method of attaching the exciter and the acoustic transmission member provided with the exciter are described below.

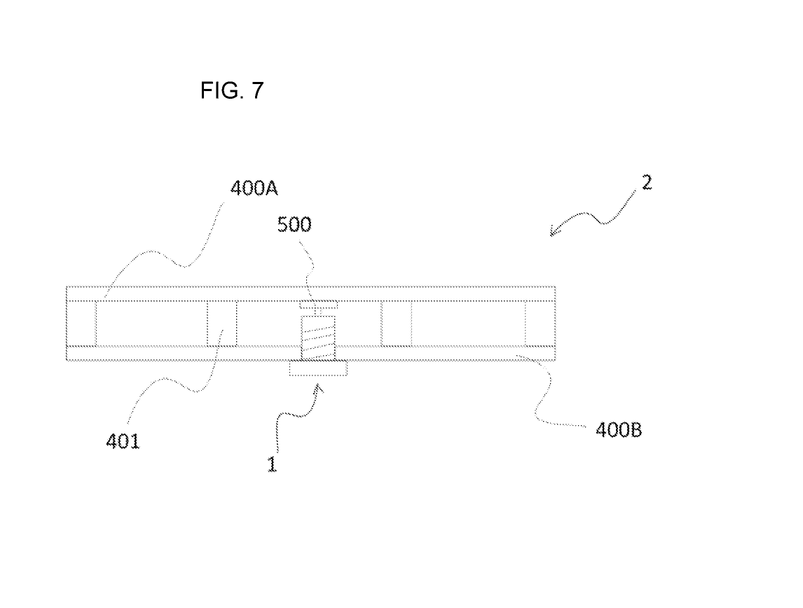

FIG. 7 is a cross-sectional view showing an example of an acoustic transmission member provided with an exciter. In this acoustic transmission member, as explained below in detail, the exciter is mounted by being screwed therein.

The acoustic transmission member 2 shown in FIG. 7 has a flush structure. In other words, the acoustic transmission member 2 consists of a first board 400A, a second board 400B facing the first board 400A, and cores 401 that are interposed between the first board 400A and the second board 400B. If the acoustic transmission member 2 is a table, typically, the first board 400A is the front plate and the second board 400B is the back plate.

An aperture is provided in the second board 400B, and the exciter 1 is screwed and fitted therein so as to pass through this aperture. The exciter 1 contacts the first board 400A through a spacer 500. With this, vibrations from the exciter 1 are transmitted to the first board 400A, and a sound can be generated from the acoustic transmission member 2. There is no restriction on the material of the spacer 500. For example, the spacer 500 may be made of metal, resin, or ceramic. It is also possible to omit the spacer 500. That is, it is possible to use a configuration wherein the exciter 1 is in direct contact with the first board 400A.

When mounting the above-mentioned exciter 1, there is no need to use a separate mounting bracket. Accordingly, the above-mentioned aperture does not need to be so large. Therefore, this aperture can be formed by a simple method such as, for example, drilling and tapping processes.

In case the above-mentioned aperture is a screw hole, it can be formed by the following method, for example. That is, first, a bottom hole corresponding to the screw diameter is created. Next, an insulating adhesive (resin) is applied to the face of the inner diameter of the bottom hole and in its vicinity. Then, this insulating adhesive (resin) is allowed to permeate and cured. Then, tapping is done. Thus, a screw hole is obtained. When a screw hole is formed in this manner, the exciter 1 can be fitted more firmly and with more stability.

Further, in case the second board 400B is not suitable for tapping etc., for example, it is also possible to screw the exciter 1 into the provided aperture by mounting a nut part or the like in the aperture. Such a nut part can be an insert nut, claw nut or flanged nut, for example. The nut part can be mounted using an adhesive, for example. As this adhesive, for example, an acrylic adhesive of two-component mixing type can be used.

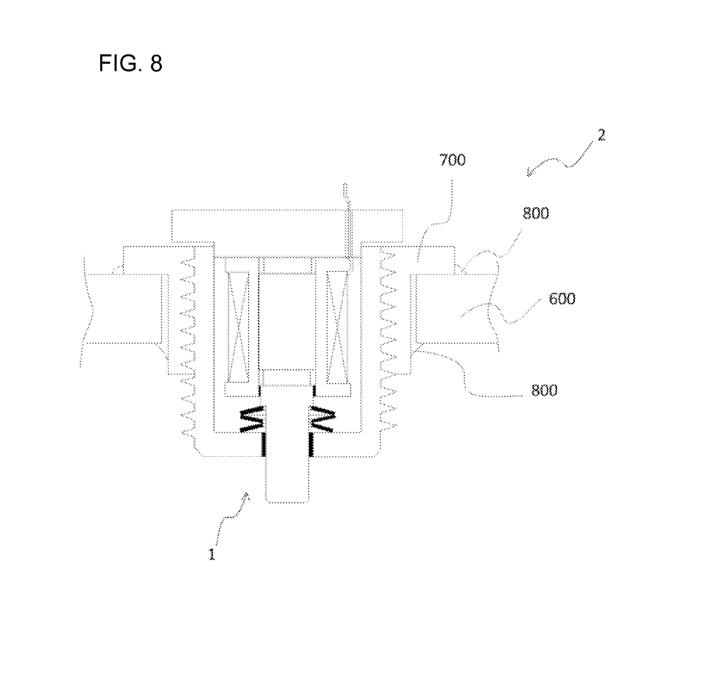

FIG. 8 is a cross-sectional view showing an example of the method of installing an exciter. In the acoustic transmission member 2 shown in FIG. 8, a flanged nut 700 is mounted to a plate 600 through an adhesive 800. The exciter 1 is fitted to the plate 600 by being screwed to the flanged nut 700.

As evident from the above explanation, the number of steps required for screw-mounting the exciter 1 is extremely small. Also, a high skill is not required for this mounting. In other words, installation of exciter 1 is easy. Therefore, by using the exciter 1, the workability at the time of installation can be significantly improved.

Also, as explained above, the exciter 1 is mounted so as to be in contact with the first board 400A either directly or indirectly through a spacer 500. Therefore, the exciter 1 can vibrate the first board 400A with high efficiency. In other words, a sound of large volume can be generated in the acoustic transmission member 2.

Moreover, the aperture provided in the second board 400B is typically blocked by the exciter 1. In this case, the inside of the acoustic transmission member 2 is nearly sealed. Therefore, due to acoustic cavity effect, the range of playback frequency by the acoustic transmission member 2 can be widened. It also becomes possible to prevent the invasion of insects etc. to the inside of the acoustic transmission member 2.

Moreover, the contact between the second board 400B and the exciter 1 may also be reinforced with an adhesive. That is, the contact between the second board 400B and the exciter 1 may also be further reinforced with screw lock processing. By doing so, the acoustic cavity effect can be displayed more prominently. Further, it also becomes possible to more reliably prevent the invasion of insects etc. to the inside of the acoustic transmission member 2. In addition, even when using the acoustic transmission member 2 for a prolonged period, the loosening of the exciter 1 can be more reliably prevented.

In addition, the extent of contact between exciter 1 and the first board 400A or spacer 500 can be adjusted by the extent of screwing of the exciter 1. Therefore, by adjusting the extent of screwing of the exciter 1, the volume of a sound generated from the acoustic transmission member 2 can be controlled.

An example of the method of mounting the exciter is explained in more detail below. In this illustrative example, exciter 1 is fitted to a circular table of flush structure. This table has a diameter of approximately 900 mm and a thickness of 30 mm. The front plate is a decorative laminate formed by pasting a melamine plate to the front side of plywood having an approximate thickness of 5.5 mm. The back plate is a laminated plywood having an thickness of approximately 5.5 mm.

First, a screw hole of M14×P2 is formed almost at the center of the back plate. The screw hole is formed as follows, for example. That is, first, a hole is created in the back plate using a portable electric drill with a diameter of 11.8 mm or a drill with a diameter of 12 mm. Next, a phenolic adhesive diluted with methanol to a desired viscosity is applied to the face that forms the inner diameter of the hole and to its vicinity. After waiting for the back plate to be impregnated with the adhesive, the adhesive is cured by hot air of a hand dryer. Next, tap processing of M14×P2 is carried out. The above-mentioned screw hole is formed in this manner.

The above-mentioned adhesive does not need to be a phenolic adhesive. For example, various types of adhesives such as cyanoacrylate, epoxy and acrylic type can be used as the above-mentioned adhesive.

Since the viscosity of cyanoacrylate adhesives is relatively low, the above-mentioned heat treatment may be omitted. Therefore, by using a cyanoacrylate adhesive, the above-mentioned operation becomes easier.

Although the viscosity of epoxy adhesives is high, the viscosity tends to significantly decrease upon heating. Thereupon, based on the experiments by the present inventors, it was proved that, when the viscosity is low, impregnation to the back plate occurs easily by capillary action or the like. Therefore, epoxy adhesives were found to be especially useful when it is required to improve the strength of the screw hole.

Moreover, the above-mentioned tapping process may be omitted in case the back plate is made of a solid wood such as lauan and teak. In this case, a hole smaller than the diameter of exciter 1 is formed. For example, when mounting the exciter 1 having a diameter of 14 mm, a hole having a diameter of approximately 13 mm is formed. When the exciter 1 is screwed into such a hole, the groove of the holder 100A will enter the surface constituting the inner diameter of the hole. By this, because of the so-called self-tap effect, screw mounting becomes possible.

The exciter 1 is screwed into the screw hole or the hole formed as described above. Here, a spacer 500 is adhered in advance on the back side of the front plate so that the exciter 1 and front plate are in contact through the spacer 500. The height of the spacer 500 is approximately 8 mm, for example. Further, there is no restriction regarding the material of this spacer 500, and a spacer made of metal, plastic, or ceramic can be used, for example. Moreover, by changing the material quality of this spacer 500, it is also possible to change the sound quality of the generated sound.

The contact between the exciter 1 and spacer 500 can be sensed by the change in resistance of screwing. At this time, a sound signal generated from an audio amplifier is input to the input lead wire 30C of the exciter 1. Thus, while generating the sound, the volume, quality and the like of a sound are adjusted by increasing/decreasing the extent of screwing. With this, an optimal sound for intended use can be generated.

Next, as needed, the above-mentioned screw-locking is carried out. By carrying out this screw-locking, as noted above, the reliability for a prolonged use can be further enhanced.

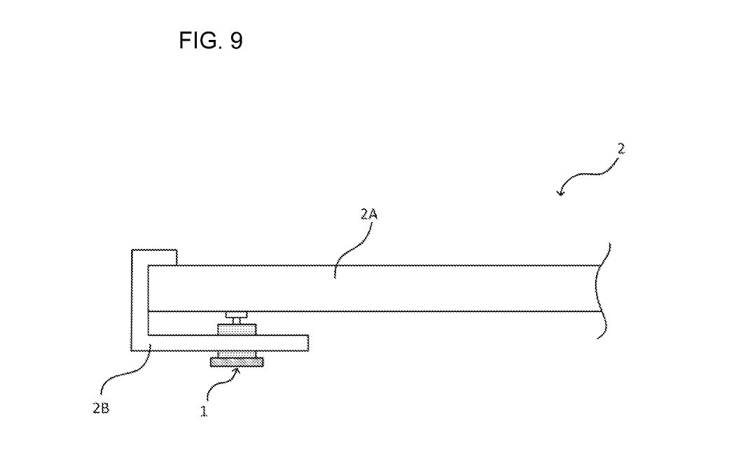

FIG. 9 is a cross-sectional view showing another example of an acoustic transmission member provided with an exciter. The acoustic transmission member 2 shown in FIG. 9 consists of a vibration member 2A and an attachment member 2B. The attachment member 2B is attached to the vibration member 2A. There is no restriction on the method of fitting the attachment member 2B. Moreover, there is also no restriction regarding the shape of the vibration member 2A. For example, the vibration member 2A can be of plate shape or tubular shape.

In the attachment member 2B shown in FIG. 9, an aperture is typically provided. In the acoustic transmission member 2 shown in FIG. 9, the exciter 1 is screwed and attached to the attachment member 2B so as to contact the vibration member 2A. By using such a configuration, it is possible to attach the exciter 1 without providing an aperture in the vibration member 2A, for example.

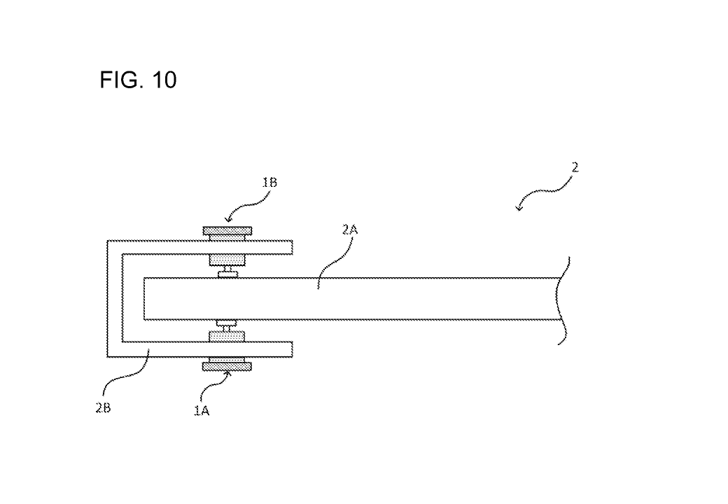

FIG. 10 shows a cross-sectional view of a modified example of the acoustic transmission member shown in FIG. 9. The acoustic transmission member 2 shown in FIG. 10 has the similar configuration as the exciter shown in FIG. 9 except for the fact that the shape of the attachment member 2B is different, and multiple exciters are installed.

The attachment member 2B shown in FIG. 10 is installed so as to sandwich the vibration member 2A. Typically, an aperture is respectively provided in this attachment member 2B on both sides of the vibration member 2A. Thereupon, in this attachment member 2B, a first exciter 1A and a second exciter 1B are attached on both sides of the vibration member 2A. By using such a configuration, for example, it is possible to attach the exciters 1 without providing an aperture in the vibration member 2A. Also, by using such a configuration, by adjusting the balance of the screw extent of exciter 1A and exciter 1B, the volume and quality of the sound can be optimized.

Thus, mounting of the exciter 1 is easy. Further, because it is also easy to remove the exciter 1, servicing etc. is also easy. Further, when installing an exciter 1 to a member having a flush structure, for example, a sound of sufficiently high volume can be generated without losing the surface aesthetics. Therefore, exciter 1 is extremely useful as compared to conventional exciters.

It should be noted that the exciter 1 may be mounted on surface of any objects. For example, the exciter 1 may be mounted anywhere on the surface of tables, doors, partitions, walls, and vehicles, etc. In particular, the exciter 1 may be mounted on rear top plate of passenger vehicles.

While the principles of the disclosure have been described above in connection with specific apparatuses and methods, it is to be clearly understood that this description is made only by way of example and not as limitation on the scope of the invention.

What is claimed is:

1. An exciter comprising:
a magnetostriction element; and
a holder encasing the magnetostriction element, wherein the holder is provided with a groove positioned on at least a part of an outer circumstance of said holder.

2. The exciter according to claim 1, further comprising:
a rod configured to transmit vibrations from the magnetostriction element to outside of the holder, wherein the rod is protruding outward from said holder.

3. The exciter according to claim 2, further comprising:
a pad provided so as to have contact with a front edge of the rod and having a diameter larger than a diameter of the rod.

4. The exciter according to claim 1, wherein the holder comprising:
a main body provided with the groove; and
a head portion integrally casted with the main body.

5. The exciter according to claim 4, wherein the head portion is hexagon bolt shaped.

6. The exciter according to claim 4, wherein the groove is formed integrally or as a separate member from the main body.

7. An acoustic transmission member comprising:
a first board;
a second board facing the first board; and
a core intervening between the first board and the second board,
wherein an exciter comprising a magnetostriction element encased by a holder is mounted on a bottom surface of the second board so as to pass through the second board and to have contact with the first board either directly or indirectly by way of a spacer.

8. The acoustic transmission member according to claim 7, wherein a groove is provided on at least a part of an outer circumstance of the holder.

9. The acoustic transmission member according to claim 8, wherein the groove is formed integrally or as a separate member from a main body of the holder.

10. The acoustic transmission member according to claim 7, wherein the exciter is mounted by screwing through an aperture formed into the second board.

11. The acoustic transmission member according to claim 10, wherein a contact between the second board and the exciter is reinforced by an adhesive.

12. The acoustic transmission member according to claim 7, further comprising:
a vibration member; and
an attachment member mounted on the vibration member,
wherein the exciter is mounted by screwing to the attachment member so as to have contact with the vibration member.

13. The acoustic transmission member according of claim 12, wherein the attachment member is mounted so as to sandwich the vibration member.

14. A method for mounting an exciter comprising:
preparing a member provided with an aperture; and
screwing an exciter having a magnetostriction element encased by a holder into the aperture.

15. The method for mounting the exciter according to claim 14, wherein the member comprising:
a first board;
a second board facing the first board and provided with the aperture; and
a core intervening between the first board and the second board,
wherein the exciter is mounted on a bottom surface of the second board so as to pass through the aperture and to have contact with the first board either directly or indirectly by way of a spacer.

16. The method for mounting an exciter according to claim 14, wherein the member further comprising:
a vibration member; and
an attachment member mounted on the vibration member and provided with the aperture.

17. The method for mounting an exciter according to claim 16, wherein the attachment member is mounted so as to sandwich the vibration member.

18. The method for mounting an exciter according to claim 14, further comprising a step of:
controlling a volume emitted from the member by adjusting an extent of the screwing.

19. The method for mounting an exciter according to claim 14, wherein the holder is provided with a groove positioned on at least a part of an outer circumstance of said holder.

20. The acoustic transmission member according to claim 19, wherein the groove is formed integrally or as a separate member from a main body of the holder.
